(19) United States
(12) Patent Application Publication
(10) Pub. No.: US 2007/0170217 A1
(43) Pub. Date: Jul. 26, 2007

(54) Pivoting frame for carrying sheet material

(76) Inventor: David A. Lemoine, Bossier City, LA (US)

Correspondence Address: John M. Harrison, 2139 E. Bert Kouns, Shreveport, LA, 71105, US

(21) Appl. No.: 11/650,800

(22) Filed: Jan. 8, 2007

Related U.S. Application Data
(60) Provisional application No. 60/761,907, filed on Jan. 26, 2006.

(51) Int. Cl. B60R 9/00

(52) U.S. Cl. 224/405; 410/100

(57) ABSTRACT

A pivoting frame for carrying sheet material, which frame is mounted in a pick-up truck bed at one side of the bed and is adjustable for receiving various types of sheet material such as sheetrock, plywood and the like. The frame is mounted to the pick-up truck bed side and floor and is designed to pivot into a first loading and unloading configuration outwardly of the pick-up truck bed at a selected access angle and inwardly of the pick-up truck bed for transportation purposes. In a preferred embodiment the pivoting arm elements of the frame are adjustable along with the frame mount, to facilitate mounting the pivoting frame in pick-up truck beds of various design.

### CROSS-REFERENCE TO RELATED APPLICATIONS

This application claims the benefit of and incorporates by reference U.S. Provisional Application Ser. No. 60/761,907, filed Jan. 26, 2006.

### BACKGROUND OF THE INVENTION

### Field of the Invention

This invention relates to devices for carrying various material, and sheet material in particular, in the beds of trucks such as pick-up trucks. More particularly, the invention includes in one embodiment a pivoting frame for carrying sheet material such as plywood, dry wall or sheetrock panels and the like, such that the pivoting frame is pivotable outwardly of the pick-up truck bed into a selected access angle for loading and unloading purposes and inwardly of the truck bed for transportation.

### SUMMARY OF THE INVENTION

The pivoting frame for carrying typically sheet material of this invention is characterized in one embodiment by a lifting arm frame that is pivotally attached to the floor and one side of a pick-up truck bed to facilitate pivoting outwardly of the pick-up truck bed over the bed side for loading and unloading purposes and inwardly of the pick-up truck bed for transportation of the loaded material. The pivoting frame is typically characterized by a pair of spaced-apart, pivoting arms connected to receivers that are pivotally mounted to one side and the floor of the pick-up truck bed. This design allows the pivoting frame to pivot outwardly of the pick-up truck bed to a desired angle and facilitates easy loading of material such as flat sheet material, including plywood, drywall or sheetrock panels and the like, on the pivoting frame. Furthermore, the panels can be strapped in place and the pivoting frame then pivoted over the bed side and inwardly of the pick-up truck bed, such that the material is positioned in a substantially vertically-oriented, locked configuration, for transportation purposes. A spring-loaded cable lock and release system may be provided on the pivoting frame arms for engaging the support frame to facilitate locking the pivoting frame into the upright transportation configuration and unlocking to pivot the pivoting frame outwardly of the pick-up truck bed for loading and unloading purposes. A pull cable may also be extended between the pivoting arms to effect manipulation of the pivoting frame to and from the loading and unloading configuration and the transportation position.

### BRIEF DESCRIPTION OF THE DRAWINGS

The invention will be better understood by reference to the accompanying drawings, wherein:

FIG. 1 is a front perspective view of a pick-up truck bed with one embodiment of the pivoting frame of this invention positioned in upright, locked transportation configuration and a panel of sheet material such as plywood, in functional position in the pivoting frame;

FIG. 2 is a front perspective view of the pick-up truck bed illustrated in FIG. 1, with the pivoting frame and plywood panel pivoted outwardly of the pick-up truck bed and over the bed side for positioning the plywood in unloading configuration;

FIG. 3 is a rear sectional view of the pick-up truck bed illustrated in FIG. 1, more particularly illustrating the plywood panel cargo and the pivoting frame in the upward-standing transportation configuration;

FIG. 4 is a rear sectional view of the pick-up truck bed illustrated in FIG. 2, more particularly illustrating the pivoting frame and panel in the outwardly pivoted loading and unloading configuration;

FIG. 5 is a rear perspective view of the pick-up truck bed illustrated in FIG. 1 with the plywood panel removed, more particularly illustrating a pivoting frame deployed in the upward-standing transportation configuration;

FIG. 6 is a rear perspective view of the pick-up truck bed illustrated in FIG. 2 with the plywood panel removed, more particularly illustrating the pivoting frame located outwardly of the pick-up truck bed for loading and unloading purposes;

FIG. 7 is a perspective view of a pivoting frame in the loading and unloading configuration and detached from the pick-up truck;

FIG. 8 is an exploded view of frame mount and pivot bar mount elements of the pivoting frame which are mounted to the bed of the pick-up truck;

FIG. 9 is an exploded view of a typical receiver leg element of the pivoting frame, more particularly illustrating a leg slot for receiving a positioning cleat and securing the sheet material on the pivoting frame; and

FIG. 10 is an exploded view of a pivoting frame for carrying sheet material of this invention.

### DESCRIPTION OF THE PREFERRED EMBODIMENTS

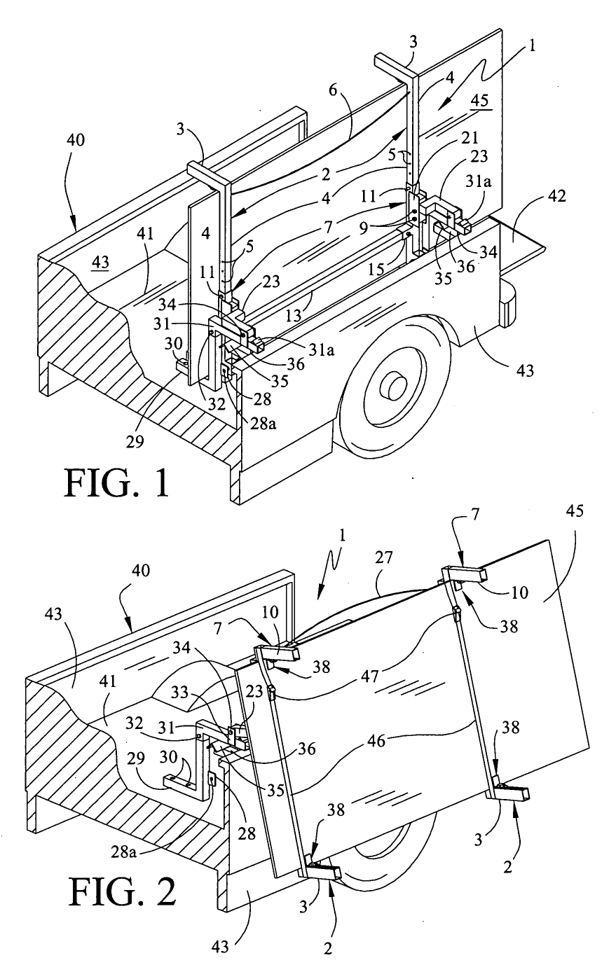

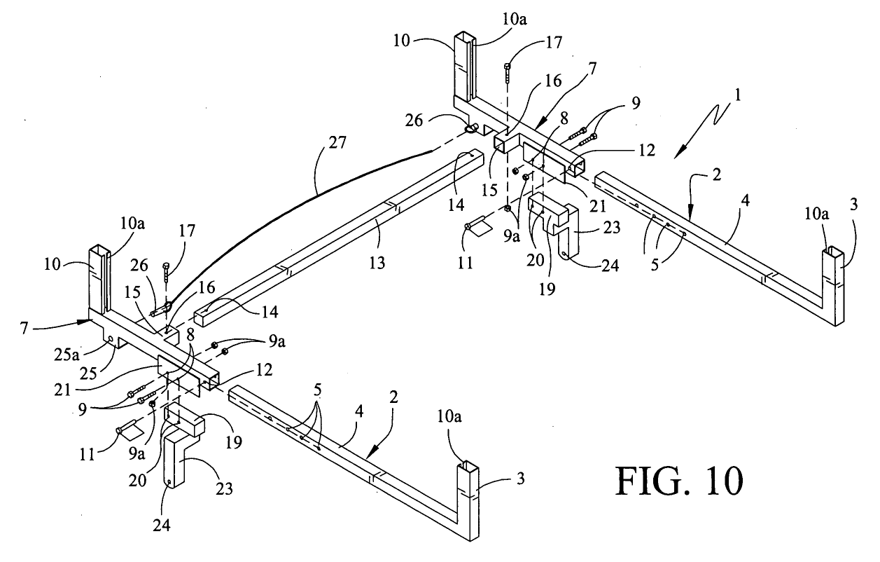

Referring initially to FIGS. 1-4 and 10 of the drawings, in a preferred embodiment of the invention a pivoting frame for carrying sheet material is illustrated by reference numeral 1. The pivoting frame 1 includes a pair of spaced-apart pivoting arms 2, each of which is characterized by a top engaging bar 3, having an engaging bar leg 4 extending from one end thereof. One or more transverse leg openings 5 are provided in each one of the engaging bar legs 4, as illustrated in FIG. 10 of the drawings and each of the engaging bar legs 4 of the pivoting arms 2 extends telescopically inside one end of a corresponding pivoting arm receiver 7, as further illustrated in FIG. 10. A pivoting arm connecting bar 13 spaces the pivoting arm receivers 7 and typically extends into a corresponding connecting bar mount 15, provided in each of the pivoting arm receivers 7. A transverse mount opening 16 is provided in each of the connecting bar mounts 15 and is designed to register with a corresponding connecting bar opening 14 in each end of the pivoting arm connecting bar 13 for receiving a mount bolt 17, which is typically secured in place by a nut 9a, as further illustrated in FIG. 10. A pair of typically spring-loaded lock pins 26 project through corresponding seat openings 25a provided in a companion lock pin seat 25, shaped in each pivoting arm receiver 7 and a lock pin cable 27 connects the lock pins 26, for a purpose which will be hereinafter further described. A receiver leg 10 extends from one end of each pivoting arm receiver 7, parallel to the top engaging bars 3 and the receiver leg 10 and top engaging bars 3 each have a slot 10a for receiving the cleat flange 39a, extending from one edge of the L-shaped cleat leg 39 of a positioning cleat 38, illustrated in FIG. 9. Alternative devices for clamping or securing a load on the pivoting arms 2 can be utilized, according to the knowledge of those skilled in the art. A cleat plate 39c has a threaded plate opening 39d that registers with a leg opening 39b in the cleat leg 39, for receiving a plate bolt 39e. An adjusting bar plate 21 is also positioned in spaced-apart relationship with respect to each pivoting arm 7 and includes spaced-apart, transverse plate openings 8, as further illustrated in FIG. 10. A receiver adjusting bar 19 fits between the respective adjusting bar plates 21 and a corresponding pivoting arm receiver 7 and is provided with a pair of spaced-apart, transverse adjusting bar openings 20 (FIG. 10) for aligning with the selected plate openings 8 in the adjusting bar plate 21 and adjustably fitting the receiver adjusting bars 19 to the corresponding pivoting arm receivers 7. Accordingly, the adjusting bars 19 are adjustable linearly along the respective pivoting arm receivers 7 to accommodate any truck bed 40. Receiver bolts 9 are designed to register with the corresponding aligned plate openings 8 and adjusting bar openings 20 for receiving nuts 9a and attaching both the adjusting bar plates 21 and the corresponding receiver adjusting bars 19 to the respective pivoting arm receivers 7. An arm adjusting pin 11 is also positioned to extend through a corresponding arm adjusting pin opening 12 provided in the respective pivoting arm receivers 7 and in a selected correspondingly aligned one of the leg openings 5, provided in the engaging bar leg 4, for adjustment purposes which will be hereinafter further described. An L-shaped pivoting bar 23 extends from each of the corresponding receiver adjusting bars 19, respectively, as further illustrated in FIG. 10 of the drawings. Each pivot bar 23 is further fitted with a corresponding pivot bar opening 24 for pivotally mounting the pivoting frame 1 in the truck bed 40 of a pick-up truck, as further hereinafter described.

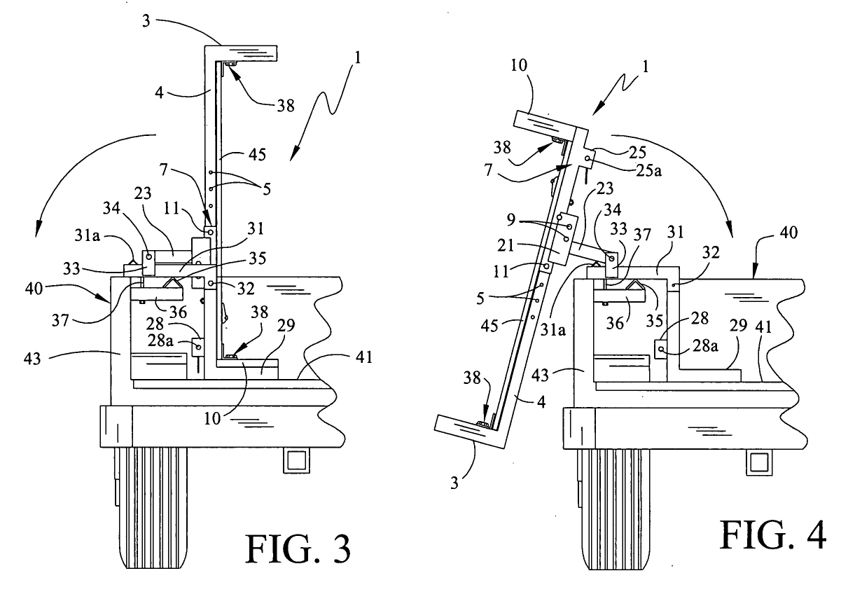

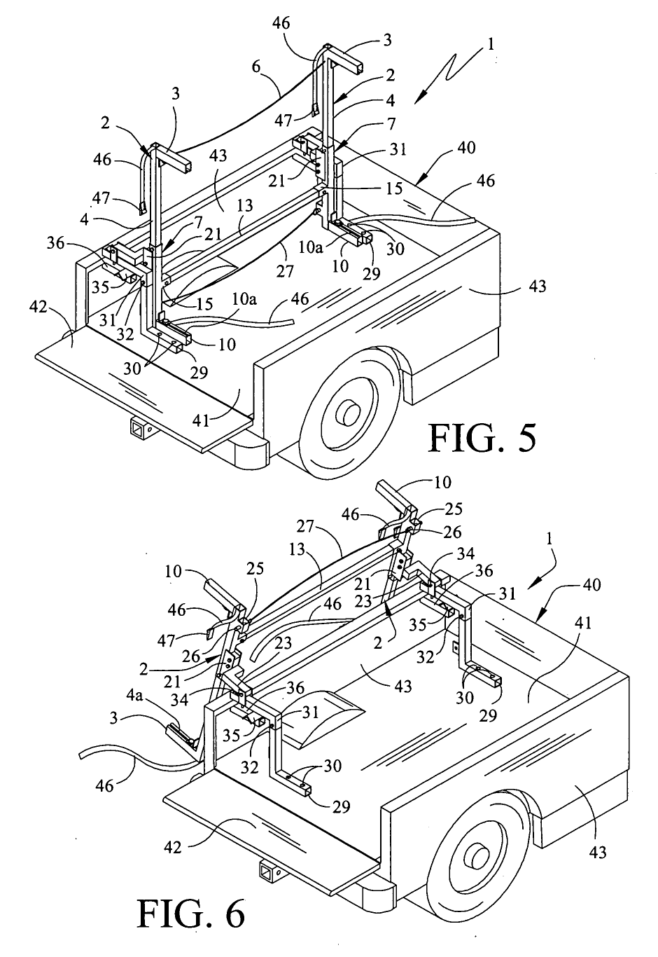

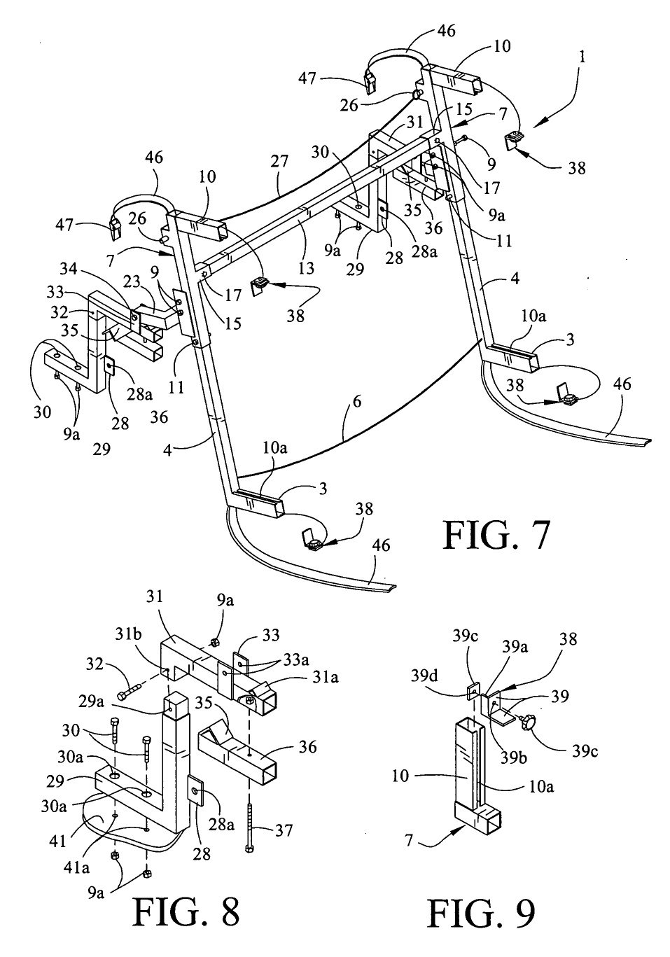

Referring now to FIGS. 1, 2 and 7-10 of the drawings, the pivoting frame 1 is pivotally secured in the truck bed 40 of a pick-up truck by a frame mount 29 and a corresponding pivot bar mount 31, particularly illustrated in FIG. 8 of the drawings. The frame mount 29 is typically secured to the bed floor 41 of the truck bed 40 using frame mount bolts 30, extending through frame mount bolt openings 30a and floor openings 41a, and secured by nuts 9a. Each pivot mount bar 31 is typically secured to the corresponding frame mount 29 by a pivot bar mount bolt 32, that extends through corresponding transverse frame mount openings 29a in the frame mounts 29 and aligned mount openings 31b in the pivot bar mounts 31. As further illustrated in FIGS. 1 and 8 of the drawings, a mount support bar 36 is typically bolted to the extending end of each pivot mount bar 31 using a mount support bar bolt 37 and a nut 9a. A mount support 35, typically characterized by a section of angle iron, is welded to the extending end of each of the mount supports 36. A bar lip 36a is welded or otherwise attached to the opposite end of the mount support bar 36 from the mount support 35 to engage the underside of the bed side 43 of the truck bed 40. The mount supports 35 are designed to receive and seat the respective pivot bar mounts 31 (FIGS. 3 and 4), which can be adjusted vertically in connection with the lateral adjustment of the receiver adjusting bars 19, as described above. The similarly-shaped mount seats 31a, provided on the pivot bar mounts 31, engage the corresponding spaced-apart pivot bars 23, mounted on the respective pivoting arm receivers 7, and limit the tilt of the pivoting frame 1 on the frame pivot pin 34 into a desired angular configuration with respect to the truck bed 40, as illustrated in FIGS. 2, 4 and 6 of the drawings. The bottom ends of the pivot bars 23 are pivotally seated in a corresponding mount cleat 33, having cleat openings 33a that align with the pivot bar openings 24, to receive the frame pivot pin 34 (FIG. 7). Accordingly, when the respective pairs of frame mounts 29 and connected pivot bar mounts 31 are mounted in the truck bed 40, along with the corresponding mount support bars 36 and mount supports 35, the pivoting frame 1 can be pivoted into the loading or unloading configuration illustrated in FIGS. 2, 4 and 6 and from that configuration over the bed side 43, into the transportation configuration illustrated in FIGS. 1, 3 and 5 of the drawings. Consequently, a plywood panel 45 illustrated in FIGS. 1-4 of the drawings can be quickly and easily loaded onto the top engaging bars 3 of the pivoting arms 2 and against the corresponding receiver legs 10 of the pivoting arm receiver 7, when the pivoting frame 1 is in the loading configuration illustrated in FIGS. 2, 4 and 6. Panel straps 46 are then applied to the plywood panel 45 and tightened using the strap buckles 47 as illustrated in FIG. 2 and the pivoting cleats 38 are adjusted and locked in the slots 10a by twisting the respective plate bolts 39e (FIG. 9). A pull cable 6 is also preferably extended between the engaging bar legs 4 by any suitable connection for rotating the pivoting frame 1 into the respective transportation and loading and unloading configurations, respectively. Alternatively, a handle or the like (not illustrated) can be attached to one or both of the pivoting arms 2 for the same purpose. The respective lock pins 26 or either one of them, then engage and seat in the respective bracket opening or openings 28a of a pair of lock pin brackets 28, attached to each of the corresponding frame mounts 29, to secure the plywood panel 45 and the pivoting frame 1 in the transportation position or configuration illustrated in FIGS. 1, 3 and 5 of the drawings. When it is desired to again pivot the pivoting frame 1 into the loading and unloading configuration, the lock pin cable 27 is grasped and tensioned to remove the respective spring-loaded lock pin or pins 26 from corresponding engagement in the corresponding seat opening or openings 25a in the respective lock pin seats 25, and facilitate grasping the pull cable 6 and rotation and pivoting of the pivoting frame 1 to the loading and unloading position illustrated in FIGS. 2, 4 and 6 from the transportation configuration illustrated in FIGS. 1, 3 and 5 of the drawings.

It will be appreciated by those skilled in the art that the pivoting frame 1 of this invention offers an attractive and convenient alternative to loading and unloading any material, but especially plywood and other sheet material such as drywall and the like, to and from the truck bed 40 of a pick-up truck, by lowering the tailgate 42 in conventional fashion. Using the pivoting frame 1, one or more of the plywood panels 45 is quickly and easily placed on the corresponding top engaging bars 3 of the corresponding pivoting arms 2 and inside the corresponding receiver legs 10 on the respective pivoting arm receiver 7. The positioning cleats 38 are then adjusted as described above in the corresponding slots 10a to seat against the plywood panel(s) 45 and are secured in place on both the top engaging bars 3 and the receiver legs 10, as further illustrated in FIG. 2 of the drawing. The pivoting frame 1 is then pivoted into the configuration illustrated in FIG. 1, using the pull cable 6, where it is locked in position by operation of the lock pin or pins 26 provided on one of each end of the lock pin cable 27, as described above. When it is desired to unload the plywood panel(s) 45 from the pivoting frame 1, the lock pin cable 27 is grasped and tensioned to remove the lock pin or pins 26 from the corresponding bracket opening or openings 28a in the companion lock pin brackets 28 and the pull cable 6 is again grasped for manipulating the pivoting frame 1 again from the position illustrated in FIG. 1 to the position illustrated in FIG. 2, to facilitate removal of the panel straps 46 at the strap buckles 47 and unloading plywood panel(s) 45.

As further illustrated in FIGS. 1 and 2 of the drawings, multiple units of the plywood panel 45 and/or drywall (sheetrock) panels or other sheet material or bulky material such as studs and the like known to those skilled in the art, may be placed or stacked on the pivoting frame 1 and typically resting on the top engaging bars 3, as desired. The entire load can then be secured with the panel straps 46 and quickly and easily pivoted into the configuration illustrated in FIG. 1 for transportation purposes. Adjustment of the length of the engaging bar legs 4 can be effected by means of the arm adjusting pin 11.

It will be further appreciated that the pivoting frame 1 can be automated using an electric or hydraulic motor or like system, according to the knowledge of those skilled in the art.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A pivoting frame for carrying a load on a truck having a truck bed, comprising a frame mount carried by the truck bed and a pair of pivoting arms pivotally carried by said frame mount, wherein said pivoting arms are selectively pivoted outwardly of the truck bed in a loading and unloading configuration and inwardly of the truck bed in a transportation configuration.

2. The pivoting frame of claim 1 wherein said frame mount comprises a pair of frame mounts mounted in the truck bed in spaced-apart relationship with respect to each other and said pivoting arms are pivotally attached to said frame mounts, respectively.

3. The pivoting frame of claim 1 comprising a lock pin carried by at least one of said pivoting arms, said lock pin removably engaging said frame mount and locking said at least one of said pivoting arms in the truck bed in said transportation configuration.

4. The pivoting frame of claim 2 comprising a pair of lock pins carried by said pivoting arms, respectively, and a lock pin cable connecting said lock pins, said lock pins removably engaging said frame mounts, respectively, and locking said pivoting arms in the truck bed in said transportation configuration responsive to release of tension in said lock pin cable, and said lock pins disengaging said frame mounts, respectively, responsive to tensioning of said lock pin cable for pivoting said pivoting arms from said transportation configuration to said loading and unloading configuration.

5. The pivoting frame of claim 1 comprising a pull cable connected to said pivoting arms for selectively pivoting said pivoting arms into said loading and unloading configuration and said transportation configuration.

6. The pivoting frame of claim 5 wherein said frame mount comprises a pair of frame mounts mounted in the truck bed in spaced-apart relationship with respect to each other and said pivoting arms are pivotally attached to said frame mounts, respectively.

7. The pivoting frame of claim 5 comprising a lock pin carried by at least one of said pivoting arms, said lock pin removably engaging said frame mount and locking said at least one of said pivoting arms in the truck bed in said transportation configuration.

8. The pivoting frame of claim 6 comprising a pair of lock pins carried by said pivoting arms, respectively, and a lock pin cable connecting said lock pins, said lock pins removably engaging said frame mounts, respectively, and locking said pivoting arms in the truck bed in said transportation configuration responsive to release of tension in said lock pin cable, and said lock pins disengaging said frame mounts, respectively, responsive to tensioning of said lock pin cable for pivoting said pivoting arms from said transportation configuration to said loading and unloading configuration.

9. The pivoting frame of claim 1 comprising at least one connector bar connecting said pivoting arms and wherein said frame mount comprises a pair of frame mounts mounted on the truck bed in spaced-apart relationship with respect to each other and said pivoting arms are pivotally attached to said frame mounts, respectively.

10. The pivoting frame of claim 9 comprising a pair of lock pins carried by said pivoting arms, respectively, and a lock pin cable connecting said lock pins, said lock pins removably engaging said frame mounts, respectively, and locking said pivoting arms in the truck bed in said transportation configuration responsive to release of tension in said lock pin cable, and said lock pins disengaging said frame mounts, respectively, responsive to tensioning of said lock pin cable for pivoting said pivoting arms from said transportation configuration to said loading and unloading configuration.

11. The pivoting frame of claim 10 comprising a pull cable connected to said pivoting arms for selectively pivoting said pivoting arms into said loading and unloading configuration and said transportation configuration.

12. A pivoting frame for carrying a load on a truck having a truck bed and bed sides, comprising a pair of frame mounts carried by the truck bed and one of the bed sides in spaced-apart relationship with respect to each other; a pair of pivoting arms pivotally carried by said frame mounts, respectively, for selectively pivoting outwardly of the truck bed and said one of the bed sides in a loading and unloading configuration, and inwardly of the truck bed and said one of the bed sides in a transportation configuration and at least one connector bar connecting said pivoting arms.

13. The pivoting frame of claim 12 comprising a lock pin carried by at least one of said pivoting arms, said lock pin removably engaging at least one of said frame mount and locking said pivoting arms in the truck bed when said pivoting arms are in said transportation configuration.

14. The pivoting frame of claim 12 comprising a pair of lock pins carried by said pivoting arms, respectively, and a lock pin cable connecting said lock pins, said lock pins removably engaging said frame mounts, respectively, and locking said pivoting arms in the truck bed in said transportation configuration responsive to release of tension in said lock pin cable, and said lock pins disengaging said frame mounts, respectively, responsive to tensioning of said lock pin cable for pivoting said pivoting arms from said transportation configuration to said loading and unloading configuration.

15. The pivoting frame of claim 12 comprising a pull cable connecting said pivoting arms for selectively pivoting said pivoting arms into said loading and unloading configuration and said transportation configuration.

16. The pivoting frame of claim 15 comprising a pair of lock pins carried by said pivoting arms, respectively, and a lock pin cable connecting said lock pins, said lock pins removably engaging said frame mounts, respectively, and locking said pivoting arms in the truck bed in said transportation configuration responsive to release of tension in said lock pin cable, and said lock pins disengaging said frame mounts, respectively, responsive to tensioning of said lock pin cable for pivoting said pivoting arms from said transportation configuration to said loading and unloading configuration.

17. A pivoting frame for carrying a load on a truck having a truck bed and bed sides, comprising a pair of spaced-apart frame mounts carried by the truck bed and one of the bed sides; a pair of pivoting arms pivotally engaging said frame mounts, respectively; and a pivot pin connecting each of said pivoting arms to said frame mounts, respectively, for selectively pivoting said pivoting arms outwardly of the truck bed and said one of the bed sides in a loading and unloading configuration and inwardly of the truck bed and said one of the bed sides in a transportation configuration.

18. The pivoting frame of claim 17 comprising at least one connector bar connected to said pivoting arms.

19. The pivoting frame of claim 18 comprising a pull cable connected to said pivoting arms for selectively pivoting said pivoting arms into said loading and unloading configuration and said transportation configuration.

20. The pivoting frame of claim 19 comprising a pair of lock pins carried by said pivoting arms, respectively, and a lock pin cable connecting said lock pins, said lock pins removably engaging said frame mounts, respectively, and locking said pivoting arms in the truck bed in said transportation configuration responsive to release of tension in said lock pin cable, and said lock pins disengaging said frame mounts, respectively, responsive to tensioning of said lock pin cable for pivoting said pivoting arms from said transportation configuration to said loading and unloading configuration.
